(19) United States
(12) Patent Application Publication
(10) Pub. No.: US 2014/0279314 A1
(43) Pub. Date: Sep. 18, 2014

(54) System and Method for Reducing and Monitoring Energy Utility Bills

(71) Applicants: Damian Ostertag, American Canyon, CA (US); Phil Mannoni, Lafayette, CA (US)

(72) Inventors: Damian Ostertag, American Canyon, CA (US); Phil Mannoni, Lafayette, CA (US)

(21) Appl. No.: 14/211,535

(22) Filed: Mar. 14, 2014

Related U.S. Application Data
(60) Provisional application No. 61/803,091, filed on Mar. 18, 2013.

(51) Int. Cl. G06Q 40/00

(52) U.S. Cl. CPC G06Q 40/12
USPC 705/30

(57) ABSTRACT

A utility auditing system for reducing and monitoring energy utility bills. The invention further relates to a “utility bill auditing savings wheel” system that creates a “Red Flag” report for identifying and fixing occurrences related to utility bill errors such as metering errors, rate errors, mathematical and clerical errors, misclassifications, missed incentives, unclaimed credits, duplicate charges and market pricing opportunities. The invention furthermore relates to a utility bill auditing system that utilizes special software for reducing and monitoring energy utility bills.

### PRIORITY CLAIM

This application claims priority to Provisional Patent Application No. 61/803,091, System For Reducing and Monitoring Energy Utility Bills, filed on Mar. 18, 2013.

### FIELD OF THE INVENTION

The present invention is generally related to a system for auditing utility bills, particularly, a utility bill auditing system that utilizes special software for reducing and monitoring energy utility bills.

### BACKGROUND OF THE INVENTION

One of the biggest problems that companies and/or individuals face with utility bills is not being able to identify errors in billing statements and being overcharged for utility services, in fact, utility billing errors and overcharges occur more often than one might expect. Metering electric use and preparing billing statements is a complicated process and many times things can and will go wrong. Common errors found in a utility bill include, but are not limited to, metering errors, rate errors, mathematical and clerical errors, misclassifications, missed incentives, unclaimed credits, duplicate charges, overlooked future looming utility penalties, overlooked market pricing opportunities and overlooked mandatory utility response reduction programs.

Meter problems can often occur since they are changed quite often in the field. A bad meter may require a utility company to estimate the readings for that month. While efforts are made to provide a fair estimate, assumptions may be imperfect. For instance, a new meter may have different multiplier settings when compared to the old meter requiring software updates that may be overlooked. The number that shows on the meter is not the actual kWh or KW. it is a meter unit that must he multiplied by a “constant” or “multiplier” to get the actual kWh or KW amount.

Problems can occur during meter reading. As mentioned above sometimes the meter reader can't get to the meter that month so the utility company has to estimate the readings. This is okay for the kWh. If it was over estimated the previous month it will correct itself at the next reading because it is a cumulative number. This is not true of the demand reading. There is no way to make sure what it actually should have been other than to have copies of bills showing the previous month or the same month from the previous year. Likewise, calculation errors can occur. Sometimes a utility company may change to a new system of calculating bills and improperly place billable items in the wrong sequence. There are taxes and fees that are applied to certain items and not to be applied to others. It is possible that taxes or special fees are applied to billing items where they should not be applied. Some taxes do not apply to schools or to certain businesses. Furthermore, line loss results in unusable energy that is still billed through the electric meter. Also, problems can occur through real power versus reactive power charges. Other problems can occur through power factor penalties and credits.

Utility companies sometimes charge the wrong rates. For example, utility companies can change the rate they give a customer in order to achieve the best rate for a customer's situation, however, they cannot look at every bill each month to see if that is occurring. Most schools' main meters have a General Service Demand rate. Customers are charged a rate for total consumption (kWh, energy charge) and a separate rate for demand (KW, peak power for that month). The second most common is the General Service rate which is simply a charge on the total consumption (kWh). In some cases a Time of Use rate may be applied. These rates should be checked periodically to make sure that clients are receiving the most economically beneficial to the client but this does get overlooked on many occasions.

There are companies that provide services for auditing utility bills which can help businesses and/or individuals to find errors and overcharges in their utility bill. However, these companies still charge a fee regardless if they find any errors or overcharges in a utility bill. Moreover, many utility companies say that they can complete a utility bill audit for companies and/or individuals. The fact is they will usually do a superficial job at best because utility companies don't necessarily hire employees whose primary job is to reduce revenue for the utility company. It is mainly up to each individual or company to find errors and overcharges and to bring them to the attention of the utility. In essence, utilities are not required to give a customer the lowest rate for which the customer qualifies. Their responsibility is to bill accurately, not cheaply.

If a utility company or a private company undertakes an energy audit, it is done primarily with the intent to sell a product. Because of this, many individuals or businesses believe that an energy audit is undertaken to determine if a company or organization should change to different light bulbs, put in extra insulation, install a solar system, or Thermopane windows, etc. Accordingly, those types of audits are not conducted to find errors or overcharges in a client's bill.

If a private utility billing auditing company undertakes a utility bill audit, it generally starts with a utility bill and then conducts a free “Red Flag” report looking for errors, misclassifications and overcharges. If a client values the errors or overcharges found within the utility bill, the utility billing auditing company will then require the client to enter into a contractual relationship with them and also agree to split the savings with them for a period of time. After entering into a contractual relationship, the auditing company then conducts a full audit to confirm and quantify the errors and overcharges originally found. A critical problem with the current approach used in the industry to audit utility bills is that several important factors are not considered such as failing to look at the energy production side of things and also failing to focus on energy demand. Because of this, many errors that could be spotted are not, thereby reducing the amount of money a client could save.

In light of the shortcomings in the prior art, a system for auditing utility bills is desired that can find errors in a bill, determine bow much a company and/or individual has been overcharged and provide information necessary to obtain a refund. In addition, a system is further desired for auditing utility hills on a contingency basis, so that there are no upfront charges to a client, and where the utility bill auditor is paid only when their work produces results for the client. Furthermore, a system is desired that takes into account the production side of things, focuses on energy demand and creates alerts or opportunities that correspond to a rate change for reducing a client's utility bill. In addition to reducing a client's utility bill, Utility Energy Solutions (LIES) “mini-systems” solar solutions can exempt a client's business from having to participate in future mandatory utility reduction programs and can also help clients to avoid future looming sanctions with stiff penalties.

### BRIEF SUMMARY OF THE INVENTION

The present invention provides anew system for monitoring and reducing energy utility bills that has novel features which is not anticipated, rendered obvious, suggested, or even implied by any utility bill auditor system, either alone or in any combination thereof. Other inventions for auditing energy utility bills have been implemented to monitor and reduce energy utility bills, but they do not include a proprietary software system that utilizes a utility bill audit savings wheel that takes into account the production side of things and that also focuses on energy demand. Focusing on the production side of things by using UES's mini-systems solar solutions can generate certain loopholes created by the ever changing language and tariff rate structures implemented by utility companies. The loopholes generated by the nature and structure of the wheel can position utility customers to be able to better protect themselves from future sanctioned utility penalties and programs. The current invention also includes a system where audits are performed on a contingency basis, so that there are no upfront charges to a client. Moreover, the current invention further includes a system that allows for savings to be shared between the client and the utility bill auditor, namely, after the auditing efforts result in savings to the client.

The present invent on also provides a system that generates alerts or opportunities corresponding to a rate change by introducing each profile point in the “utility bill auditing savings wheel” system to energy or demand usage that results in demand usage being reduced which in turn reduces a client's utility bill. Moreover, reducing demand usage reduces the cost of future capital energy investment costs to a client's business. Hence, reducing demand usage lifts the restrictive utility rate structure and opens opportunity for a client to jump into a more cost effective rate structure.

The present invention also provides a new utility auditing system for monitoring and reducing a client's utility bill which may be easily and efficiently designed, programmed and marketed.

Accordingly, for a better understanding of the invention, its operating advantages and the specific advantages attained by its uses, reference should be made to the accompanying drawings and descriptive matter in which there are illustrated preferred embodiments of the invention.

### BRIEF DESCRIPTION OF THE DRAWINGS

FIG. 1 is one embodiment of the invention for monitoring and reducing an energy utility bill that utilizes profile points that are monitored and analyzed in a “utility bill auditing savings wheel” system.

FIG. 2 is the preferred embodiment of the invention that outlines the process and services for monitoring and reducing an energy utility bill that utilizes profile points in a “utility bill auditing savings wheel” system.

FIG. 2 (a)-(g) is a flow diagram of the steps involved in the invention for monitoring and reducing an energy utility bill.

FIG. 3 is another embodiment of the invention for monitoring and reducing an energy utility bill that utilizes profile points that are monitored and analyzed in a “utility bill auditing savings wheel” system.

FIG. 3 (a)-(g) identifies profile points used in the invention.

FIG. 4 is yet another embodiment of the invention for monitoring and reducing an energy utility bill that utilizes profile points to create rate changes or rate opportunities that are monitored and analyzed in a “utility bill auditing savings wheel” system.

FIG. 5 is one embodiment of the invention that depicts the contingent approach for splitting savings between a client and a utility billing auditing company.

FIG. 6 is one embodiment of the invention illustrating emerging utility trends.

FIG. 7 is a flow diagram illustrating the current method connected to a particular machine or apparatus.

FIG. 8 is a flow diagram illustrating the current method connected to a particular machine or apparatus.

### DETAILED DESCRIPTION OF THE INVENTION

FIG. 1 illustrates an embodiment of the present invention for monitoring and reducing an energy utility bill that utilizes a “utility bill auditing savings wheel” system that creates a “Red Flag” report. The “Utility Bill Audit” profile point is the starting point of the “audit savings wheel” system where a client simply submits a copy of their last month's utility bill for electricity and natural gas (including propane) to Utility Energy Solutions (U.E.S.). The client will then request a free “Red Flag” report by including a bill for each meter and each utility involved. Also, the Utility Bill Audit is a detailed audit of all utility bills received (electrical, natural gas, water, fuel, waste and telecom). Moreover, see FIGS. 2 (a)-(g) that outline the steps involved for monitoring and reducing an energy utility bill.

Once the utility bill has been received by a trained auditor for U.E.S., the audit will then be conducted using U.S.E.'s proprietary software system. Once the initial audit is complete, a U.E.S. auditor will contact the client regardless if “Red Flags” are found or not. If the U.E.S. auditor does spot any “Red Flags,” he or she will notify the client to suggest whether or not a full-fledged audit at no “up front” cost to the client should be done. (See FIGS. 7-8), Some of the “Red-Flags” identified for each profile point are indications of rate optimization that would otherwise go unnoticed within a traditional utility audit. In addition to errors found in a utility bill, the “audit savings wheel” system will often find cost saving opportunities for companies that have high energy expenses due to large amounts of pump and motor usage, expensive lighting costs and natural gas usage.

If a client values the errors found in the “Utility Bill Audit” and decides to go forward with a full-fledged audit, U.E.S. will need two items to proceed. First, it will need an authorization from the client to contact their utility company to obtain at least 6 months of their bills. Secondly, a signed agreement has to be in place between the client and U.E.S. so that U.E.S. can get paid after the client collects on the refund due to them. Similarly, the savings and refunds come from identifying and fixing common occurrences of metering errors, rate errors, mathematical and clerical errors, misclassifications, missed incentives, unclaimed credits, duplicate charges and market pricing opportunities.

FIGS. 1-4 illustrate the “audit savings wheel” system that conducts a detailed audit by taking into consideration such factors as Utility Bill Auditing, Advanced Monitoring, Advanced Lighting or LED, Demand Response, Energy Storage, Energy Production, eMonitor, anyComm, Stem, and UBS “mini-systems” solar solution or ‘Solar Wind Fuel Cell’. Similarly, see FIGS. 3 (a)-(g) that identify each profile point of the invention. Furthermore, the order of conducting the audit, as illustrated in FIGS. 1-4, is important for truly benchmarking a client's facility within the new utility trends, resulting in credits or penalties earned as a result. Common errors found by the “audit savings wheel” system include metering errors, rate errors, mathematical and clerical errors, misclassifications such as missed deregulation opportunities, missed incentives, unclaimed credits provided by such things as tariffs and/or ordinances, duplicate charges and overlooked market pricing opportunities that could include tariffs, ordinances and deregulated opportunities. Likewise, the “audit savings wheel” system can also spot certain areas of energy expenses where new technology or recently enacted laws could enable a business to lower its energy expenses. Furthermore, the “audit savings wheel” system can help a client to benchmark its business and facilities for lowering energy costs and for identifying billing errors in the future.

The current invention includes the UES “mini-systems” solar solution feature that enables a client to create loophole exemption status from peak demand utility pricing, demand response penalties, etc. that are analyzed at the Energy Production profile point of the process. In essence, the UES “mini-systems” solar solution feature creates a loophole for clients who may not have the hundreds of thousands to invest into a commercial solar system. Now, all a client needs is just one solar panel to be installed to take advantage of net metering laws that require changing an existing smart meter (that reads demand for the PDP penalties in 2014) and forces a meter change to a solar production meter (that does not read demand) making one exempt from participating in the future mandatory PDP events. Moreover, this feature of the invention helps a client to avoid an average of 700% utility cost increases, 15 days a year, for a mandatory utility reduction event. Also, this feature of the invention saves clients thousands since they can avoid penalties and also realize no demand charges. To take advantage of this feature of the invention, all a client has to do is have U.E.S, install the system for free and then split the savings for a period of time with U.E.S.

As shown in FIGS. 1-4, the “audit savings wheel” system focuses on demand in order to save its clients money on their utility bill. In addition, the system also considers a utility bill from a production perspective and not just on a consumption level. The wheel further includes the advanced feature of creating errors also called alerts or opportunities that would not normally occur and these alerts or opportunities save clients money because the system takes into account the production side of things in a utility bill and the system also focuses on demand for advanced monitoring. In essence, where there are generally no rate errors to be found, the “audit savings wheel” generates alerts or opportunities that correspond to a rate change by creating an opportunity to present such things as a new rate schedule and/or rate change by affecting demand usage.

After all errors and overcharges have been identified in a utility bill by the “audit savings wheel” system, corrections are made and then there are generally two primary courses of action that take place. First, U.E.S. handles the required paper work and obtains a refund for the client from the utility company. Second, the client's utility bill is reduced by the amount of all errors for future bills and is then audited by U.E.S. corresponding to the number of months in the contract, to make certain no future errors occur.

When the auditing efforts result in savings to the client, those savings are shared between the client and U.E.S. as illustrated in FIG. 5. In fact, U.E.S. will notify the utility of the incorrect billing determined during the audit and will then ask the utility to correct it. When the client then gets their new utility bill, U.E.S. will show them their billable savings for using its auditing services. Following the audit, U.E.S. will continue to monitor accounts every month for 43 months or for the number of months agreed upon in the contract, to insure no old errors repeat and no new errors Occur since it is not unusual for utilities to change their rates as often as 5 times every year, giving rise to many errors going forward. Also, emerging utility trends can occur often as illustrated in FIG. 6. If no new errors and savings are found, there is no charge to the client. If new errors are discovered, U.E.S. will share the savings for that time period with the client.

What is claimed is:

1. In a utility bill audit savings wheel system, a method for monitoring and reducing a utility bill with respect to utility billing data registered into the system, a predetermined order for profile points decided beforehand for calculating demand usage, said method comprising the following steps:
analyzing the utility billing data at each profile point;
calculating Red-Flags at each profile point for identifying errors and overcharges in a utility bill;
generating alerts or opportunities that correspond to a rate change based on each profile point that addresses demand usage;
calculating the reduced demand usage based on the predetermined profile points; and
generating a Red-Flag report for each profile point that displays errors and overcharges in the utility bill.

2. A computer-aided method for monitoring and reducing a utility bill by means of a computer processor for processing utility billing data registered into a utility bill audit savings wheel system, a predetermined order of profile points decided beforehand for calculating demand usage, said method comprising the following steps:
analyzing, via the processor, the utility billing data at each profile point;
calculating, via the processor, Red-Flags at each profile point for identifying errors and overcharges in a utility bill;
generating, via the processor, alerts or opportunities that correspond to a rate change based on each profile point that addresses a demand usage;
calculating, via the processor, the reduced demand usage based on the predetermined profile points; and
generating, via the processor, a Red-Flag report for each profile point that displays errors and overcharges in the utility bill.

3. (canceled)

4. A method for monitoring and reducing a utility bill by means of a computer processor, wherein a computer memory is operatively connected to the computer processor, a data storage device having a data store, wherein the data storage device and the data store can be queried by the processor, a computer readable medium operatively connected to the processor, said medium having machine readable code embodied therein to control and to direct a utility bill audit system having utility billing data and at least one profile point registered into said system for calculating demand usage, said method comprising the following steps:
analyzing the utility data at each profile point;
calculating Red-Flags at each profile point for identifying errors and overcharges in a utility bill;
generating alerts or opportunities that correspond to a rate change based on each profile point that addresses demand usage;
calculating the reduced demand usage based on the predetermined profile points; and
generating a Red-Flag report for each profile point that displays errors and overcharges in the utility bill.

5. (canceled)

6. (canceled)
